(19) United States
(12) Patent Application Publication
(10) Pub. No.: US 2019/0100225 A1
(43) Pub. Date: Apr. 4, 2019

(54) Self Centering Railcar Brake Shoe

(71) Applicant: Trinity North American Freight Car, Inc., Dallas, TX (US)

(72) Inventor: Shaun Richmond, Frankfort, IL (US)

(21) Appl. No.: 15/724,371

(22) Filed: Oct. 4, 2017

(51) Int. Cl. B61H 13/36; F16D 65/06

(52) U.S. Cl. CPC B61H 13/36; F16D 65/062

(57) ABSTRACT

An apparatus includes a frame, a braking material and a guide material. The frame includes a braking portion and a guide portion. The braking portion extends generally circumferentially around a surface of a wheel. The guide portion is coupled to the braking portion. A first part of the guide portion extends from the braking portion proximate to a first end of the braking portion over a portion of the wheel. The braking material is coupled to the braking portion of the frame. The braking material provides frictional force opposing rotational movement of a wheel when a force is applied between the braking material and the wheel. The guide material is couple to the guide portion of the frame. The guide material is coupled to the guide portion of the frame.

### TECHNICAL FIELD

This disclosure generally relates to railcar brake shoes, and more particularly to self-centering railcar brake shoes.

### BACKGROUND

Railcars are integral to the transportation of goods across the country. Railcars may include brake rigging systems that enable the railcars to reduce the speed or halt the railcar when desired. The brake rigging may include one or more brake beams that move brake shoes towards the wheels of the railcar in order to oppose the rotational movement of the wheels using friction. The brake shoes of the railcar brake rigging system may cause wear to the wheels. Excessive or uneven wear on portions of the wheel, such as the flange of the wheel, or may require the removal and replacement of the wheel.

### SUMMARY

Particular embodiments described herein include an apparatus including a frame, a braking material, and a guide material. The frame includes a braking and a guide portion. The braking portion extends generally circumferentially around a surface of a wheel. The guide portion is coupled to the braking portion. A first part of the guide portion extends from the braking portion proximate to a first end of the braking portion over a portion of the wheel. The braking material provides frictional force opposing rotational movement of a wheel when a force is applied between the braking material and the wheel. The guide material is coupled to the guide portion of the frame.

In particular embodiments, a second part of the guide portion extends from the braking portion proximate to a second end of the braking portion.

In particular embodiments, the first and second parts of the guide portion extend from the braking portion radially towards a center of the wheel.

In particular embodiments, the braking portion of the frame includes a first braking section and a second braking section. The braking material is coupled to the each of the first and second braking sections and forms at least two separated braking pads.

In particular embodiments, the frame is coupled to a brake beam of a railcar. The brake beam positions the frame adjacent to the wheel such that the at least a portion of the braking material contacts the surface of the wheel and the guide portion overlaps a portion of the wheel.

In particular embodiments, the guide portion of the frame and the guide material reduce lateral movement of the brake beam while the railcar is in motion.

In particular embodiments, the braking material includes a high friction material.

In particular embodiments, the guide material includes a low friction material.

In particular embodiments, the guide portion of the frame deposits a portion of the guide material on the wheel. The deposited portion of the guide material reduces erosion of the guide material from the guide portion of the frame.

In another embodiment, the disclosure includes an apparatus including a brake beam, a first braking component and a second braking component. The brake beam includes comprising a first receiver at a first end of the brake beam and a second receiver at a second end of the brake beam. Each of the first and second braking components includes a frame, a braking material, and a guide material. The frame includes a braking and a guide portion. The braking portion extends generally circumferentially around a surface of a wheel. The guide portion is coupled to the braking portion. A first part of the guide portion extends from the braking portion proximate to a first end of the braking portion over a portion of the wheel. The braking material is coupled to the braking portion of the frame. The braking material provides frictional force opposing rotational movement of a wheel when a force is applied between the braking material and the wheel. The guide material is coupled to the guide portion of the frame. The first braking component is coupled to the first end of the brake beam at the first receiver of the brake beam. The second braking component is coupled to the second end of the brake beam at the second receiver of the brake beam. The brake beam is disposed adjacent to a first wheel and a second wheel and is configured to apply frictional force to the first wheel by the high friction material of the first braking component and to the second wheel by high friction material of the second braking component.

In particular embodiments, the guide portions of the frames of the first and second braking components are configured to reduce lateral movement of the brake beam while the first and second wheels are in motion.

In particular embodiments, the first and second wheels each comprise a flange. The guide material coupled to the guide portion of the frame of the first braking component opposes lateral movement of the brake beam such that the braking material coupled to the braking portion of the frame of the first braking component maintains a distance from the flange of the first wheel. The guide material coupled to the guide portion of the frame of the second braking component opposes lateral movement of the brake beam such that the braking material coupled to the braking portion of the frame of the second braking component maintains a distance from the flange of the second wheel.

In particular embodiments, the braking portion of the frame of each of the first braking component and the second baking component includes a first braking section and a second braking section. The braking material is coupled to the each of the first and second braking sections forming at least two separated braking pads.

In particular embodiments, the guide portion of the frame of each of the first braking component and second braking component includes a first guide section and a second guide section. The guide material coupled to each of the first and second guide portions form at least two sections of guide material separated a distance apart.

In particular embodiments, the brake beam positions the frame of the first braking component adjacent to the first wheel and the frame of the second braking component adjacent to the second wheel such that the at least a portion of the braking material of each of the first and second braking components contacts the surface of the first and second wheels and the guide portions of each of the first and second braking components overlaps a portion of the wheel.

In particular embodiments, the braking material includes a high friction material.

In particular embodiments, the guide material includes a low friction material.

In particular embodiments, the guide portions of the frames of the first and second braking components deposit a portion of the guide material on the first and second wheels.

The deposited portion of the guide material reduces erosion of the guide material from the guide portion of the frames of the first and second braking components.

According to yet another embodiment, the disclosure includes a method including providing a brake beam. The brake beam including a first receiver at a first end of the brake beam and a second receiver at a second end of the brake beam. The method further includes providing a first braking component and a second braking component. Each of the first and second braking components includes a frame, a braking material, and a guide material. The frame includes a braking and a guide portion. The braking portion extends generally circumferentially around a surface of a wheel. The guide portion is coupled to the braking portion. A first part of the guide portion extends from the braking portion proximate to a first end of the braking portion over a portion of the wheel. The braking material is coupled to the braking portion of the frame. The braking material provides frictional force opposing rotational movement of a wheel when a force is applied between the braking material and the wheel. The guide material is coupled to the guide portion of the frame. The first braking component is coupled to the first end of the brake beam at the first receiver of the brake beam. The second braking component is coupled to the second end of the brake beam at the second receiver of the brake beam. The method further includes disposing the brake beam adjacent to a first and a second wheel. The method further includes applying frictional force to the first wheel by the braking material of the first braking component and to the second wheel by braking material of the second braking component.

In particular embodiments, the method further includes reducing lateral movement of the brake beam while the first and second wheels are in motion by disposing the guide portions of the frames of the first and second braking components over a portion of each of the first and second wheels.

In particular embodiments, the first and second wheels each comprise a flange. Applying frictional force to the first wheel includes opposing lateral movement of the brake beam. Lateral movement of the brake beam is opposed using the guide material coupled to the guide portion of the frame of the first braking component such that the braking material coupled to the braking portion of the frame of the first braking component maintains a distance from the flange of the first wheel. Lateral movement of the brake beam is opposed using the guide material coupled to the guide portion of the frame of the second braking component such that the braking material coupled to the braking portion of the frame of the second braking component maintains a distance from the flange of the second wheel.

As a result, particular embodiments of the present disclosure may provide numerous technical advantages. For example, particular embodiments reduce the lateral movement of the brake beam. Limiting the lateral range of the brake beam in relation to the wheels may prevent the brake shoe from contacting certain portions of the wheel, such as the flange of the wheel. Additionally, particular embodiments may prevent the erosion of the guide portion of the self-centering brake shoe by depositing a portion of the guide material on a surface of the wheel. The deposited guide material may coat a portion of the wheel in contact with the guide portion, limiting the friction between the wheel and the guide portion. As yet another example, particular embodiments may allow the guide portion to overlap the side of the wheel even when the brake beam is not operated to provide braking to the wheels. In this manner, the brake beam may be centered before the application of the braking action. Particular embodiments of the present disclosure may provide some, none, all, or additional technical advantages.

### BRIEF DESCRIPTION OF THE DRAWINGS

A more complete and thorough understanding of the particular embodiments and advantages thereof may be acquired by referring to the following description taken in conjunction with the accompanying drawings, in which like reference numbers indicate like features, and wherein:

FIG. 1 illustrates an example railcar, according to some embodiments;

FIG. 2 illustrates an example a brake rigging system of a railcar, according to some embodiments.

FIG. 3A-C illustrate an example self-centering brake shoe, according to some embodiments;

FIG. 4 illustrates an example brake rigging system using the example self-centering brake shoe of FIG. 3, according to some embodiments;

FIG. 5 illustrates a further example brake rigging system using the example self-centering brake shoe of FIG. 3, according to some embodiments; and

FIG. 6 is a flowchart diagram of an example method of braking in a railcar.

### DETAILED DESCRIPTION

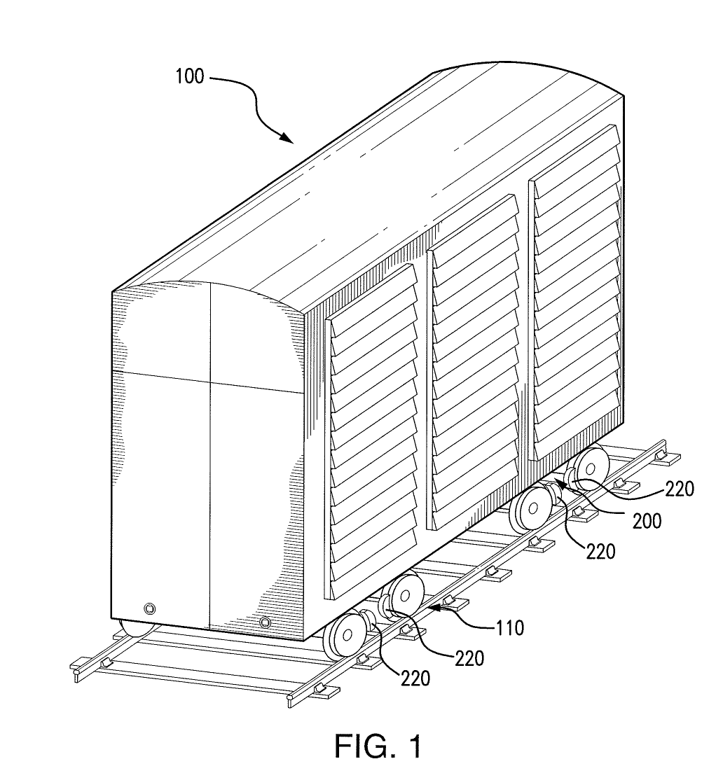

Embodiments of the present disclosure and its advantages are best understood by referring to FIGS. 1 through 6 of the drawings, like numerals being used for like and corresponding parts of the various drawings.

Railroads and railcars are an integral part of the transportation system, carrying cargo and persons to various places across the country. Railcars require the ability to reduce their speed in order to navigate portions of the railroad track, such as in corners or in low-speed areas. Likewise, railcars must be able to reduce their speed and stop to allow the loading and unloading of cargo. Railcars include brake rigging systems that allow the railcar to be slowed in response to an operator or in some cases, automatically based on certain criteria.

Conventional systems use brake shoes to apply frictional force to the surface of the wheels of the railcar to reduce their rotational speed, thereby slowing the railcar. To apply the frictional force, the brake shoes mounted on a brake beam, and the brake beam is moved to cause contact between the brake shoes and the wheels. Typically, the brake rigging system of the railcar causes the brake beam to be moved towards the wheels unevenly causing the brake shoes to contact the wheels unevenly. The uneven contact may cause uneven wear on the wheels, which may require additional maintenance or earlier replacement. Additionally, the uneven contact may allow the brake shoe to contact portions of the wheel that may wear quicker or require replacement due to less wear. For example, a brake shoe may contact a flange of the wheel, which may require the replacement of the entire wheel if the flange is too thin from the brake shoe wear over time. Without any mechanism to ensure the even application of the brake shoes, the wheels of the railcar may be damaged or worn excessively, which may impair the use of the railcar or reduce the safety its operation.

The present disclosure contemplates an unconventional self-centering brake shoe and method that may prevent the uneven contact and wear described above. The self-centering brake shoe may include a guide portion which stabilizes the lateral position of the braking portion of the brake shoe. By preventing undesired lateral movement of the brake shoe, the braking portion providing the frictional resistance may be evenly applied to the wheel surface and prevented from contacting sensitive parts of the wheel or moving off the edge of the wheel. In this manner, the wear on railcar wheels may be reduced, thereby increasing their operational lifetimes and the safety of their use on the railcar.

FIG. 1 illustrates an example railcar 100, according to some embodiments. Railcar 100 may be any railcar, train, or vehicle configured to run on railroad tracks In certain embodiments, railcar 100 includes a plurality of wheels 110. Wheels 110 may have an interior-facing side oriented toward the undercarriage of railcar 110 and exterior-facing side opposite the interior-facing side. Wheels 110 may also include a wheel surface that rotates with wheels 110 and contacts the rail tracks. Railcar 100 may also include a brake rigging system 200 that enables railcar 100 to reduce its speed. Brake rigging system 200 may include one or more brake shoes 220. Brake shoes 220 may contact the wheel surface of wheels 110 to reduce the rotational momentum of wheels 110 to slow down railcar 110.

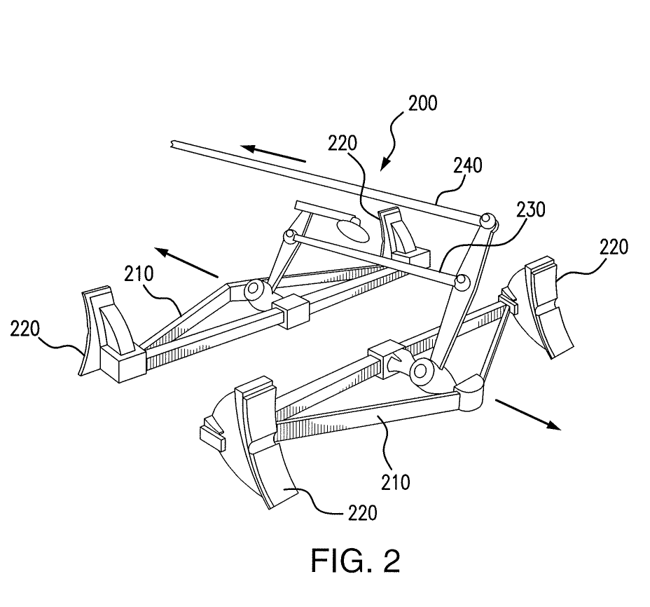

FIG. 2 illustrates an example brake rigging system 200 of railcar 100, according to some embodiments. Brake rigging system 200 may include one or more brake beams 210. Brake beams 210 may include two or more receivers on which a pair of braking components may be mounted. For example, two brake shoes 220 may be coupled to opposite sides of one of brake beams 210. Each brake beam 210 may be disposed adjacent to wheels 110 on opposite sides of railcar 100. In certain embodiments, brake beam 210 is configured to apply frictional force opposing the motion of wheels 110 by moving brake beams 210 towards wheels 110 to provide contact between each of brake shoes 220 and wheels 110 of railcar 100.

In certain embodiments multiple brake beams 210 may be coupled together by bottom rod 230. By coupling brake beams 210 together, multiple brake beams 210 may be moved to cause brake shoes 220 to reduce the speed of wheels 110 at the same with the same force. In certain embodiments, a top rod 240 is coupled to one of brake beams 210 to provide force to move brake beams 210. Top rod 240 may move in a direction away from coupled brake beam 210, causing coupled brake beam 210 to move in the opposite direction. Due to the coupled bottom rod 230, the uncoupled brake beam 210 may move in the direction away from the coupled brake beam 210. Thus, both brake beams 210 may be moved towards wheels 110 in a symmetric way using top rod 240 and bottom rod 230.

Typically, top rod 240 is not centered exactly along the length of railcar 100. For example, top rod 240 may be rotated by a small angle with respect to the axis running along the length of railcar 100. This is often required to navigate top rod 240 through other components in the undercarriage of railcar 100. As a result, top rod 240 may apply an uneven force to brake beams 210 such that brake beams 210 twist or move laterally to one side. Without any mechanism to prevent this motion, brake beams 210 may cause brake shoes 220 to contact wheels 110 unevenly. Other misalignments may cause brake shoes 220 to contact wheels 110 unevenly. For example, bent or warped levers coupling brake beam 210 to top rod 240 and/or bottom rod 230 may similarly cause a twisting motion.

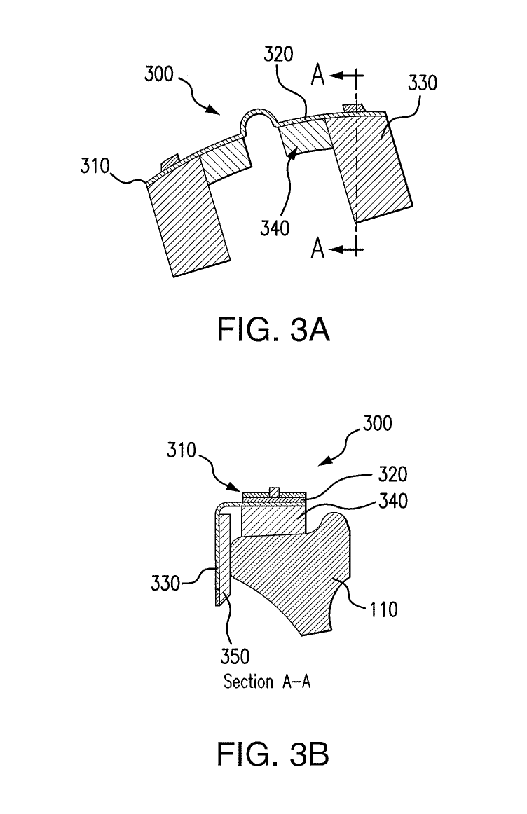

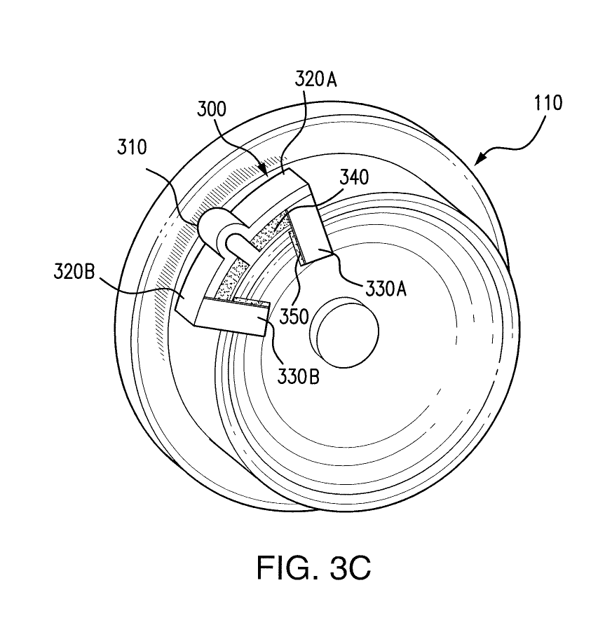

FIG. 3A illustrates an example self-centering brake shoe 300, according to some embodiments. In certain embodiments, self-centering brake shoe 300 may counteract the twisting and lateral forces on brake beams 210 to ensure the even application of self-centering brake shoe 300. In certain embodiments, self-centering brake shoe 300 may include a frame 310. Frame 310 may include a braking portion 320 and a guide portion 330. Braking portion 320 may enable brake shoe 300 to provide the braking force to slow down or stop railcar 100. Guide portion 330 may ensure the even application of the braking force by counteracting any twisting or lateral force on brake beams 210.

In certain embodiments, braking portion 320 extends generally circumferentially around a surface of a wheel, such as one of wheels 110. In some embodiments, braking portion 320 may have a curved portion extending along a tangential direction around an axis. For example, the curved portion of braking portion 320 may curve in a direction aligned with the circumference of one of wheels 110 for some portion thereof. In some embodiments, the whole of braking portion 320 is curved along the tangential direction of the outer surface of one of wheels 110. In this manner, braking portion 320 may be disposed around a portion of one of wheels 110 to maximize the contact area between braking portion 320 and the rotating surface of one of wheels 110 and to aid in the even application of the braking force.

In certain embodiments, frame 310 includes a braking material 340 coupled to braking portion 320. Braking material 340 may be aligned facing the surface of one of wheels 110 when braking shoe 300 is disposed over one of wheels 110. In particular embodiments, braking material 340 is configured to provide frictional force opposing rotational movement of a wheel, such as one of wheels 110, when a force is applied between braking material 340 and the wheel. For example, a force may be applied to braking shoe 300 to contact surface of braking material 340 to the surface of one of wheels 110. The contact between braking material 340 and the surface of one of wheels 110 may produce a frictional force opposing the rotation of one of wheels 110, thereby reducing its momentum and slowing railcar 100. The level of frictional force opposing rotation of the one of wheels 110 may be controlled based on the applied force to braking shoe 300 or portions thereof

In particular embodiments, braking material 340 comprises a high friction material. The high friction material may enable braking material 340 to reduce the momentum of one of wheels 110 by providing a high frictional coefficient. The high friction material may be any suitable material or composition of materials that produce a high frictional coefficient between braking material 340 and the surface of one of wheels 110. In some embodiments, the high friction material of braking material 340 corresponds to a particular type of wheel. For example, a high friction material may be used in braking material 340 for use on a steel tire on one of wheels 110 of railcar 100. In this manner, braking material 340 may adequately provide the desired braking force to wheels 110.

In certain embodiments, guide portion 330 is coupled to braking portion 320 of frame 310. In some embodiments, guide portion 330 and braking portion 320 comprise a monolithic portion of frame 310. Alternatively, guide portion 330 and braking portion 320 may be separate portions of frame 310 coupled by a fastener or other means, such as an adhesive or interlocking structure, between guide portion 330 and braking portion 320.

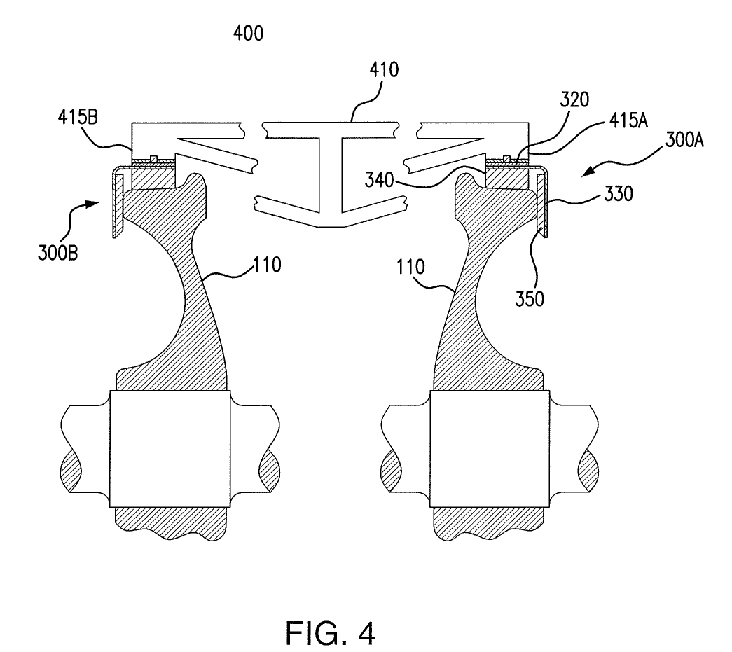

In certain embodiments, a first part of guide portion 330 extends from braking portion 320 proximate to a first end of braking portion 320 over a portion of one or more wheels. For example, as shown in the illustrated example, guide portion 330 may extend in a radial direction, generally perpendicular to the tangential direction along which a portion of braking portion 320 may extend. In some embodiments, a second part of guide portion 330 extends from braking portion 320 proximate to a second end of braking portion 320. In this example, guide portion 330 may include two separated guide portion sections, each of which extends generally perpendicularly to a different portion of braking portion 320. In some embodiments, guide portion 330 consists of a single guide portion section. Guide portion 330 may extend generally perpendicularly to braking portion 320 so that at least a part of guide portion 330 may be disposed to the exterior of one of wheels 110 in relation to railcar 100 as described in further detail in FIGS. 3C and 4 below. In this manner, guide portion 330 may prevent twisting or lateral movement of a coupled brake beam, such as one of brake beams 210.

In certain embodiments, frame 310 further comprises a guide material 350 coupled to guide portion 330. Guide material 350 may contact an exterior-facing portion of one of wheels 110. The contacting portion of guide material 350 may provide a surface on which a force may be exerted by one of wheels 110 to brake shoe 300 to one of brake beams 210 in order to counteract any twisting or lateral force caused by top rod 240 and/or bottom rod 230 during operation. For example, if one of brake beams 210 moves brake shoe 300 laterally towards the center of railcar 100, guide material 350 of guide portion 330 may contact the exterior-facing surface of one of wheels 110. One of wheels 110 may provide a counteracting force, generally in the axial direction of one of wheels 110, that prevents the lateral movement of brake shoe 300. In this manner, guide portion 330 and guide material 350 may reduce lateral movement of one of brake beams 210 while railcar 100 is in motion.

In certain embodiments, guide material 350 comprises a low friction material. Guide material 350 may comprise a material configured to allow the corrective force from one of wheels 110 to translate to braking shoe 300 without significantly impacting or changing the rotational momentum of wheels 110. For example, guide material 350 may comprise a low friction material comprising one or more of a ultrahigh molecular weight polyethylene (UHMW), a nylon, or a polytetrafluoroethylene (PTFE). The low friction material may reduce frictional forces between guide material 350 and wheels 110.

In particular embodiments, guide portion 330 may be disposed over a portion of the exterior-facing portion one of wheels 110 even when no braking force is applied to one of wheels 110. In other words, guide material 350 may contact and allow corrective force to align braking shoe 300 before and after braking material 340 is made to contact the rotating surface of one of wheels 110. In this manner, the corrective force preventing twisting and lateral movement of brake beams 210 may be maintained throughout operation of railcar 110 and reduce the strain and stress of applying those forces over longer periods of time.

In certain embodiments, guide portion 330 of frame 310 may be configured to deposit a portion of guide material 350 on one of wheels 110. For example, a portion of guide material may erode from guide portion 330 onto an exterior-facing portion of one of wheels 110 and coat the portion of one of wheels 110 where guide material 350 makes contact. By depositing a portion of guide material 350 on one of wheels 110, friction at the contact surface may be further reduced. For example, after depositing guide material 350 on one of wheels 110, the remaining guide material 350 on guide portion 330 may be in contact with a coating of guide material 350, as opposed to the material of one of wheels 110, such as a steel. The deposited portion of guide material 350 may reduce erosion of guide material 350 from guide portion 330 of frame 310. In the case of guide material 350 comprising a low friction material, the now two surfaces of low friction material may have a significantly reduced frictional force between them, which lessens the erosive effect of the relative movement of the surfaces and protects the remaining portion of guide material 350. Preventing further erosion may also help extend the lifetime of guide portion 330.

Guide portion 330 and braking portion 320 of frame 310 may comprise any suitable material. For example, each of guide portion 330 and braking portion 320 may comprise a metal, such as a steel, that maintains its shape under high stress forces during operation in brake shoe 300. In a particular example, guide portion 330 may comprise of a material allowing guide portion 330 to maintain its relative position to braking portion 320 such that it continues to oppose any twisting or lateral motion of brake beams 210.

In certain embodiments, braking portion 320 of frame 310 includes a first braking section 320A and a second braking section 320B. Braking material 340 may be coupled to each of first and second braking sections 320A-B to form two separated braking pads. Providing more than one braking pad may enhance the braking of wheels 110. For example, providing separated braking pads, frame 310 may be configured to flex under force by brake beams 210 against the rotating surface of wheels 110. This flexing may ensure that the area of braking material 340 contacting wheels 110 is maximized. Further, providing separated braking pads may reduce the strain on frame 310 in response to any misalignment or any mismatch between the shapes of braking portion 320 and the surface of wheels 110. In some embodiments, braking portion 320 consists of a single braking section. The size and shape of the single braking section may be configured to maximize the contact area between braking portion 320 and wheel 110.

In certain embodiments, guide portion 330 includes a first guide section 330A and a second guide section 330B. In some embodiments, first guide section 330A and second guide section 330B, may each extend from braking portion 320 from a first and second end of braking portion 320, respectively. Guide material 350 may be coupled to each of first and second guide sections 330A-B to form at least two sections of guide material separated a distance apart. As described above, guide portion 330 and guide material 350 may provide counteracting forces to brake beams 210 to prevent twisting or lateral movement. Providing two separated sections of guide portion 330 may reduce the localization of stress and strain caused by those counteracting forces. For example, the forces may be spread over a larger area of guide material 350, thereby reducing the overall pressure on guide portion 330. Additionally, first and second guide sections 330A-B help align the counteracting force more effectively than a single guide section. For example, a twisting motion of brake beams 210 may not be easily counteracted by a single guide section of guide portion 330. The strain of such a motion may be localized to only one side of guide portion 330, increasing the speed at which that side may fail or deteriorate. By placing two or more sections of guide portion 330 over the exterior surface of one of wheels 110, the twisting motion may be prevented without enhanced wear.

FIG. 3B illustrates a cross section of self-centering brake shoe 300 of FIG. 3A. The example brake shoe 300 is illustrated disposed over one of wheels 110 in a braking mode. In a braking mode, brake beams 210 may be operated to move brake shoe 300 towards one of wheels 110 such that braking material 340 contacts the surface of one of wheels 110. During this braking mode, guide portion 330 and guide material 350 may prevent brake shoe 300 from moving laterally beyond a certain range. For example, in the illustrated embodiment, guide portion 330 limits the position of braking portion 320 from left to right. In certain embodiments, guide portion 330 may be configured to prevent braking portion 320 from contacting a flange of one of wheels 110. In this manner, braking portion 320 may not produce a frictional force to the flange of wheels 110, reducing their wear and increasing their operational lifetime. Additionally, pairs of brake shoes 300 disposed on opposite sides of railcar 100 may reduce the lateral movement of the opposite brake shoe 300. In this manner, braking portion 320 may be prevented from slipping off the rotating surface of wheel 110, e.g., in the left direction in FIG. 3B.

FIG. 3C illustrates an isometric view of self-centering brake shoe 300 of FIGS. 3A and 3B disposed over one of wheels 110. In the illustrated embodiment, brake shoe 300 may include frame 310 comprising first and second braking sections 320A-B with braking material 340 coupled thereon. Frame 310 of brake shoe 310 may further include first and second guide sections 330A-B with guide material 350 coupled thereon. As described above, brake portion 320 may extend generally circumferentially around a surface of a wheel. In this manner, brake shoe 300 may expose braking material 340 to the surface of one of wheels 110, which then may provide a braking force to reduce the rotational momentum of one of wheels 110. Additionally, guide sections 330A-B may extend from first and second ends of braking portion 320, respectively. In some embodiments, first and second guide sections 330A-B may extend from braking portion 320 radially towards a center of one of wheels 110. In some embodiments, first and second guide sections 330A-B may extend from braking portion 320 away from one or more of first and second ends. In some embodiments, first and second guide portions 330A-B may extend in a direction other than radially towards a center of one of wheels 110. For example, guide sections 330A-B may extend at an angle off of the radial direction. As described above, the disposal of guide sections 330A-B over the side of wheel 110 may prevent undesired lateral and twisting movement caused by the uneven application of force to brake beam 210.

FIG. 4 illustrates an example brake rigging system 400 using the example self-centering brake shoe 300 of FIGS. 3A and B, according to some embodiments. Railcar 100 may comprise one of more brake beams 410 coupled to a brake rigging system 400. Each of one or more brake beams 410 may comprise a first receiver 415A and a second receiver 415B. Each of first and second receivers 415A-B may be configured to receive a portion of a braking component, such as self-centering brake shoe 300, and couple the braking component to brake beam 410. For example, first and second receivers 415A-B may each define a receiving slot or hole through which a brake shoe key may be inserted. The brake shoe key may couple self-centering brake shoe 300 to brake beam 410 through one of first or second receivers 415A-B.

In certain embodiments, a first brake shoe 300A and a second brake shoe 300B may be coupled to one brake beam 410 on opposite sides of railcar 100. Each of first and second brake shoes 300A-B may be coupled to brake beam 410 using any suitable means. For example, each of first and second brake shoes 300A-B may be coupled to brake beam 410 using a brake shoe key disposed through a portion of frame 310 of each of first and second brake shoes 300A-B and each of a first and second receiver of brake beam 410. In this manner, first and second brake shoes 300A-B may be secured to brake beam 410.

As described above, in certain embodiments, guide portions 330 and guide materials 350 of first and second brake shoes 300A-B may be configured to reduce the lateral movement of brake beam 410 during operation of railcar 100. For example, guide portion 330 and guide material 350 of first brake shoe 300A may prevent braking portion 320 and braking material 340 of first brake shoe 300A from moving inward toward the center of railcar 100. This may prevent braking material 340 from contacting undesired portions of wheel 110, such as a flange of wheel 110. Similarly, second brake shoe 300B may prevent its respective braking material from contacting undesirable portions of the wheel of wheels 110 over which it is disposed.

Additionally, in certain embodiments each of first and second brake shoes 300A-B are configured to prevent the other's braking portion 320 and braking material 340 from slipping off the side of the rotating surface of its wheel of wheels 110. If braking portion 320 and braking material 340 move over the edge of wheel 110, when operated to create a braking force, braking material 340 may have a reduced contact, or none at all, with wheel 110. As a result, the frictional force provided by braking shoe 300 may be reduced, reducing the efficiency of brake shoe 300 and increasing the failure rate in braking maneuvers. For example, first brake shoe 300A on the right of FIG. 4 may prevent second brake shoe 300B on the left of FIG. 4 from laterally moving to the left beyond a certain position. Guide portions 330 of each brake shoe 300 may be configured to allow only a certain combined distance between opposite wheels 110 and guide material 350 of guide portions 330. This distance may be less than the width of the rotating surface of wheel 110 such that braking portion 320 and braking material 340 may not move beyond the edge of wheel 110. In this manner, braking shoes 300 may enhance the braking of railcar 100 by maintaining the entire surface of braking material 340 available to reduce the speed of wheels 110.

In certain embodiments, guide portion 330 may overlap the exterior facing surface of one of wheels 110 when braking material 340 is not contacting one of wheels 110. For example, guide portion 330 may extend radially towards the center of one of wheels 110 for a distance greater than the separation between braking material 340 the surface of one of wheels 110 when brake beam 410 is not engaged to reduce the speed of railcar 100. In this manner, brake beams 210 may maintain a proper alignment during operation of the railcar and enable the even application of braking force when engaged.

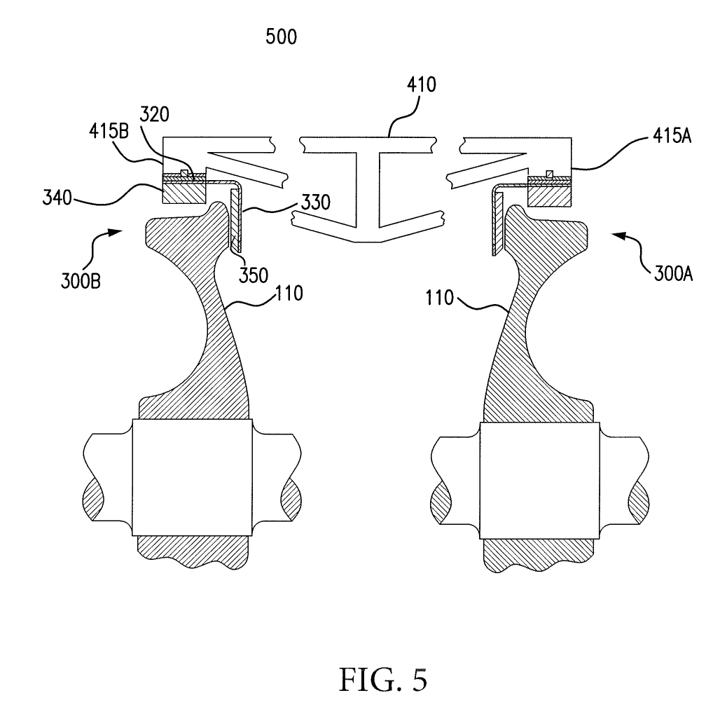

FIG. 5 illustrates a further example brake rigging system 500 using the example self-centering brake shoe 300 of FIGS. 3A and B, according to some embodiments. While certain embodiments described above are described with guide portion 330 disposed over an exterior portion of one of wheels 110 in relation to railcar 100, in certain embodiments, guide portion 330 may be disposed over the interior of one of wheels 110. In such a configuration, guide portion 330 may also prevent twisting or lateral movement of a coupled brake beam, such as one of brake beams 210. For example, guide material 350 may instead contact an interior-facing portion of one of wheels 110. Thus, the contacting portion of guide material 350 may analogously provide a surface on which a force may be exerted by one of wheels 110 to brake shoe 300 to one of brake beams 210 in order to counteract any twisting or lateral force caused by top rod 240 and/or bottom rod 230 during operation. For example, if one of brake beams 210 moves brake shoe 300 laterally away from the center of railcar 100, guide material 350 of guide portion 330 may contact the interior-facing surface of one of wheels 110. One of wheels 110 may provide a counteracting force, generally in the axial direction of one of wheels 110, that prevents the lateral movement of brake shoe 300. In this manner, guide portion 330 and guide material 350 may reduce lateral movement of one of brake beams 210 while railcar 100 is in motion.

In certain embodiments, a portion of guide material may erode from guide portion 330 onto an interior-facing portion of one of wheels 110 and coat the portion of one of wheels 110 where guide material 350 makes contact. By depositing a portion of guide material 350 on one of wheels 110, friction at the contact surface may be further reduced.

In the interior-facing embodiments, two brake shoes 300 may be coupled to opposite sides of brake beams in similar manner as described in FIG. 4 above, but instead of having both guide portions 330 exterior to each of wheels 110, guide portions 330 may face the interior of each of wheels 110, as illustrated in FIG. 5. Brake rigging system 500 may operate similarly to brake rigging system 400 with interior-facing guide portions 330. For example, each of first and second brake shoes 300A-B would be configured to prevent the other's braking portion 320 and braking material 340 from slipping off the side of the rotating surface of its wheel of wheels 110 or moving to far towards the interior of railcar 100. For example, first brake shoe 300A of brake rigging system 500 of FIG. 5 may prevent second brake shoe 300B brake rigging system 500 of FIG. 5 from laterally moving to the right beyond a certain position and vice versa. Guide portions 330 of each brake shoe 300 may be configured to allow only a certain combined distance between opposite wheels 110 and guide material 350 of guide portions 330. This distance may be less than the width of the rotating surface of wheel 110 such that braking portion 320 and braking material 340 may not move beyond the edge of wheel 110. In this manner, braking shoes 300 may enhance the braking of railcar 100 by maintaining the entire surface of braking material 340 available to reduce the speed of wheels 110. Thus, in certain embodiments, brake shoes 300 may be configured to be disposed such that guide portions 330 are interior-facing, as shown in FIG. 5, in addition or alternatively to being exterior-facing, as illustrated in the examples in FIGS. 3 and 4.

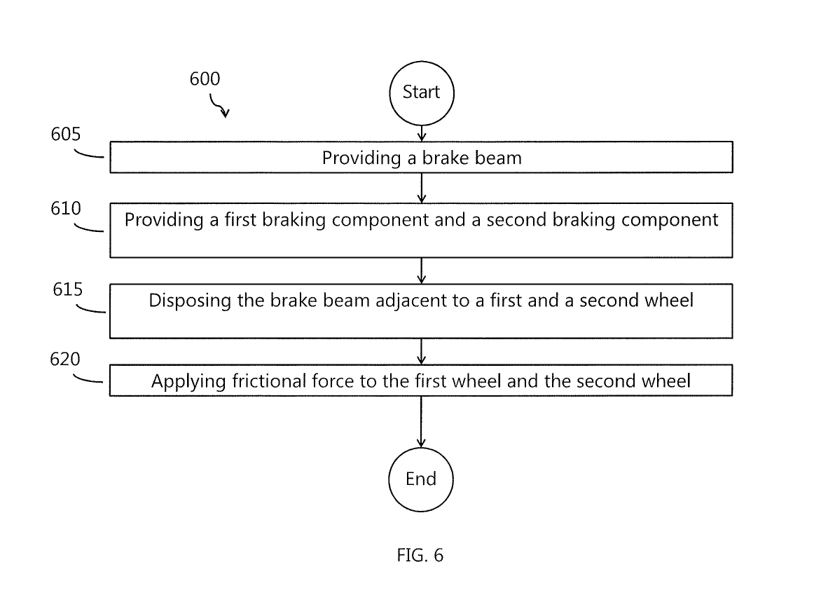

FIG. 6 is a flowchart diagram of an example method 600 of braking in a railcar. In particular embodiments, various components of brake rigging system 400 and/or brake rigging system 500 may perform one or more steps or portions thereof of method 600.

Method 600 may begin at step 605. At step 605, brake beam 410 may be provided. Brake beam 410 may comprise a first receiver at a first end of brake beam 410 and a second receiver at a second end of brake beam 410 opposite of the first end.

At step 610, a first braking component and a second braking component may be provided. For example, a first brake shoe 300A and a second brake shoe 300B may be provided. Each of first and second brake shoes 300A-B may include frame 310 comprising braking portion 320 and guide portion 340, braking material 340, guide material 350. The first braking component may be coupled to the first end of brake beam 410 at the first receiver of brake beam 410 and the second braking component may be coupled to the second end of brake beam 410 at the second receiver of brake beam 410. In this manner, braking components may be provided at opposite ends of brake beam 410.

At step 615, brake beam 410 is disposed adjacent to a first wheel and second wheels. For example, brake beam 410 may be disposed adjacent to two of wheels 110 on opposite sides of railcar 100. For example, brake beam 410 may be disposed over two wheels of wheels 110 sharing an axle. In certain embodiments, disposing brake beam 410 adjacent to first and second wheels includes disposing surfaces of braking material 340 of first and second brake shoes 300A-B adjacent to rotating surfaces of first and second wheels.

At step 620, frictional force is applied to the first wheel by braking material of first braking component and applied to the second wheel by braking material of the second braking component. For example, frictional force may be applied by moving brake beam 410 to move first and second brake shoes 300A-B towards wheels 110 to cause contact between its respective braking material 340 and the rotating surface of each wheel. In this manner, the speed of railcar 100 may be reduced.

In certain embodiments, method 600 may include additional steps. For example, method 600 may further include the additional step of reducing lateral movement of brake beam 410 by disposing guide portions 330 of frames 310 of the first and second braking components over a portion of the first and second wheels. For example, a portion of guide portion 330 of frame 310 of first brake shoe 300A may be disposed over an exterior-facing portion of one of wheels 110 to prevent lateral movement. Similarly, a portion of guide portion 330 of frame 310 of second brake shoe 300B may be disposed over an exterior-facing portion of an opposite wheel of wheels 110 to prevent lateral movement. In some embodiments, each of the first and second wheel of wheels 110 may include a flange. Method 500 may include the steps to oppose the lateral movement of brake beam 410 using guide material 350 of each of the first and second braking components to maintain a distance between the flange and braking material 340 of each braking component.

Modifications, additions, or omissions may be made to method 600 depicted in FIG. 6. Method 600 may include more, fewer, or other steps. For example, each of the steps may be performed in parallel or in any suitable order. While discussed as various components of brake rigging system 400 and/or brake rigging system 500 performing the steps, any suitable component of combination of components of brake rigging system 400 and/or brake rigging system 500 may perform one of more steps of method 600.

As a result, particular embodiments of the present disclosure may provide numerous technical advantages. For example, particular embodiments reduce the lateral movement of the brake beam. Limiting the lateral range of the brake beam in relation to the wheels may prevent the brake shoe from contacting certain portions of the wheel, such as the flange of the wheel. Additionally, particular embodiments may prevent the erosion of the guide portion of the self-centering brake shoe by depositing a portion of the guide material on a surface of the wheel. The deposited guide material may coat a portion of the wheel in contact with the guide portion, limiting the friction between the wheel and the guide portion. As yet another example, particular embodiments may allow the guide portion to overlap the side of the wheel even when the brake beam is not operated to provide braking to the wheels. In this manner, the brake beam may be centered before the application of the braking action. Particular embodiments of the present disclosure may provide some, none, all, or additional technical advantages.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components.

Although embodiments of the present disclosure and their advantages have been described in detail, it should be understood that various changes, substitutions and alternations can be made herein without departing from the spirit and scope of the invention as defined by the claims below.

1. An apparatus, comprising:
a frame comprising:
a braking portion extending generally circumferentially around a surface of a wheel;
a guide portion coupled to the braking portion, wherein a first part of the guide portion extends from the braking portion proximate to a first end of the braking portion over a portion of the wheel;
a braking material coupled to the braking portion of the frame, the braking material configured to provide frictional force opposing rotational movement of the wheel when a force is applied between the braking material and the wheel; and
a guide material coupled to the guide portion of the frame.

2. The apparatus of claim 1, wherein a second part of the guide portion extends from the braking portion proximate to a second end of the braking portion.

3. The apparatus of claim 2, wherein the first and second parts of the guide portion extend from the braking portion radially towards a center of the wheel.

4. The apparatus of claim 1, wherein the braking portion of the frame comprises a first braking section and a second braking section, wherein the braking material is coupled to the each of the first and second braking sections forming at least two separated braking pads.

5. The apparatus of claim 1, wherein the frame is coupled to a brake beam of a railcar and the brake beam is configured to position the frame adjacent to the wheel such that the at least a portion of the braking material contacts the surface of the wheel and the guide portion overlaps a portion of the wheel.

6. The apparatus of claim 5, wherein the guide portion of the frame and the guide material are configured to reduce lateral movement of the brake beam while the railcar is in motion.

7. The apparatus of claim 1, wherein the braking material comprises a high friction material.

8. The apparatus of claim 1, wherein the guide material comprises a low friction material.

9. The apparatus of claim 1, wherein the guide portion of the frame is configured to deposit a portion of the guide material on the wheel, wherein the deposited portion of the guide material is configured to reduce erosion of the guide material from the guide portion of the frame.

10. An apparatus comprising:
a brake beam comprising a first receiver at a first end of the brake beam and a second receiver at a second end of the brake beam;
a first braking component and a second braking component, each of the first and second braking components comprising:
a frame, comprising:
a braking portion generally circumferentially around a surface of a wheel;
a guide portion coupled to the braking portion, wherein a first part of the guide portion extends from the braking portion proximate to a first end of the braking portion over a portion of the wheel;
a braking material coupled to the braking portion of the frame, the braking material configured to provide frictional force opposing rotational movement of a wheel when a force is applied between the high friction material and the wheel; and
a guide material coupled to the guide portion of the frame;
wherein the first braking component is coupled to the first end of the brake beam at the first receiver of the brake beam and the second braking component is coupled to the second end of the brake beam at the second receiver of the brake beam;
wherein the brake beam is disposed adjacent to a first wheel and a second wheel and is configured to apply frictional force to the first wheel by the high friction material of the first braking component and to the second wheel by high friction material of the second braking component.

11. The apparatus of claim 10, wherein the guide portions of the frames of the first and second braking components are configured to reduce lateral movement of the brake beam while the first and second wheels are in motion.

12. The apparatus of claim 10, wherein:
the first and second wheels each comprise a flange;
the guide material coupled to the guide portion of the frame of the first braking component is configured to oppose lateral movement of the brake beam such that the braking material coupled to the braking portion of the frame of the first braking component maintains a distance from the flange of the first wheel; and
the guide material coupled to the guide portion of the frame of the second braking component is configured to oppose lateral movement of the brake beam such that the braking material coupled to the braking portion of the frame of the second braking component maintains a distance from the flange of the second wheel.

13. The apparatus of claim 10, wherein the braking portion of the frame of each of the first braking component and the second baking component comprises a first braking section and a second braking section, wherein the braking material is coupled to the each of the first and second braking sections forming at least two separated braking pads.

14. The apparatus of claim 10, wherein the brake beam is configured to position the frame of the first braking component adjacent to the first wheel and the frame of the second braking component adjacent to the second wheel such that the at least a portion of the braking material of each of the first and second braking components contacts the surface of the first and second wheels and the guide portions of each of the first and second braking components overlaps a portion of the wheel.

15. The apparatus of claim 10, wherein the braking material comprises a high friction material.

16. The apparatus of claim 10, wherein the guide material comprises a low friction material.

17. The apparatus of claim 10, wherein the guide portions of the frames of the first and second braking components are configured to deposit a portion of the guide material on the first and second wheels, wherein the deposited portion of the guide material is configured to reduce erosion of the guide material from the guide portion of the frames of the first and second braking components.

18. A method, comprising:
providing a brake beam comprising a first receiver at a first end of the brake beam and a second receiver at a second end of the brake beam;
providing a first braking component and a second braking component, each of the first and second braking components comprising:
a frame, comprising:
a braking portion extending generally circumferentially around a surface of a wheel;
a guide portion coupled to the braking portion, wherein a first part of the guide portion extends from the braking portion proximate to a first end of the braking portion over a portion of the wheel;
a braking material coupled to braking portion of the frame, the braking material configured to provide frictional force opposing rotational movement of a wheel when a force is applied between the high friction material and the wheel; and
a guide material coupled to the guide portion of the frame;
wherein the first braking component is coupled to the first end of the brake beam at the first receiver of the brake beam and the second braking component is coupled to the second end of the brake beam at the second receiver of the brake beam;
disposing the brake beam adjacent to a first and a second wheel;
applying frictional force to the first wheel by the braking material of the first braking component and to the second wheel by braking material of the second braking component.

19. The method of claim 18, further comprising reducing lateral movement of the brake beam while the first and second wheels are in motion by disposing the guide portions of the frames of the first and second braking components over a portion of each of the first and second wheels.

20. The method of claim 18, wherein:
the first and second wheels each comprise a flange; and
applying frictional force to the first wheel comprises:
opposing lateral movement of the brake beam using the guide material coupled to the guide portion of the frame of the first braking component such that the braking material coupled to the braking portion of the frame of the first braking component maintains a distance from the flange of the first wheel; and
opposing lateral movement of the brake beam using the guide material coupled to the guide portion of the frame of the second braking component such that the braking material coupled to the braking portion of the frame of the second braking component maintains a distance from the flange of the second wheel.
